(19) United States
(12) Patent Application Publication
(10) Pub. No.: US 2014/0117954 A1
(43) Pub. Date: May 1, 2014

(54) POWER SUPPLY CIRCUIT

(71) Applicant: HON HAI PRECISION INDUSTRY CO., LTD., New Taipei (TW)

(72) Inventors: HUNG-YI WANG, New Taipei (TW); HSIANG-PIN TSENG, New Taipei (TW); MIN-WEI LEE, New Taipei (TW)

(21) Appl. No.: 13/912,456

(22) Filed: Jun. 7, 2013

(30) Foreign Application Priority Data
Oct. 25, 2012 (TW) 101139585

(51) Int. Cl. H02M 3/158

(52) U.S. Cl. CPC H02M 3/158
USPC 323/271

(57) ABSTRACT

A power supply circuit is configured to supply a working voltage for an electric load. The power supply circuit includes a controller and a power supply module connected to the controller. The power supply module includes a first output channel and a second output channel both of which are connected to the electric load. A current sensor is connected to the controller and configured to sense a current output from the first output channel. Either the first output channel or the second output channel is deactivated by the controller when the current sensed by the current sensor is less than a predetermined current value. Both of the first output channel and the second output channel are activated when the current sensed by the current sensor is greater than the predetermined current value.

### BACKGROUND

1. Technical Field

The present disclosure relates to power supply circuits, and particularly to a power supply circuit capable of providing a single phase or a two-phase power supply to an electric load.

2. Description of Related Art

A two-phase power supply circuit can be applied to a motherboard for supplying a working voltage to a graphic processing unit (GPU). However, when the GPU is idle or only needs to execute a few tasks, a single phase power supply is more suitable for the GPU. The typical power supply circuit cannot select between a single phase or two-phase power supply mode according to a working state of the GPU.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an embodiment of a power supply circuit.

FIG. 2 is a detailed circuit of a controller of the power supply circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

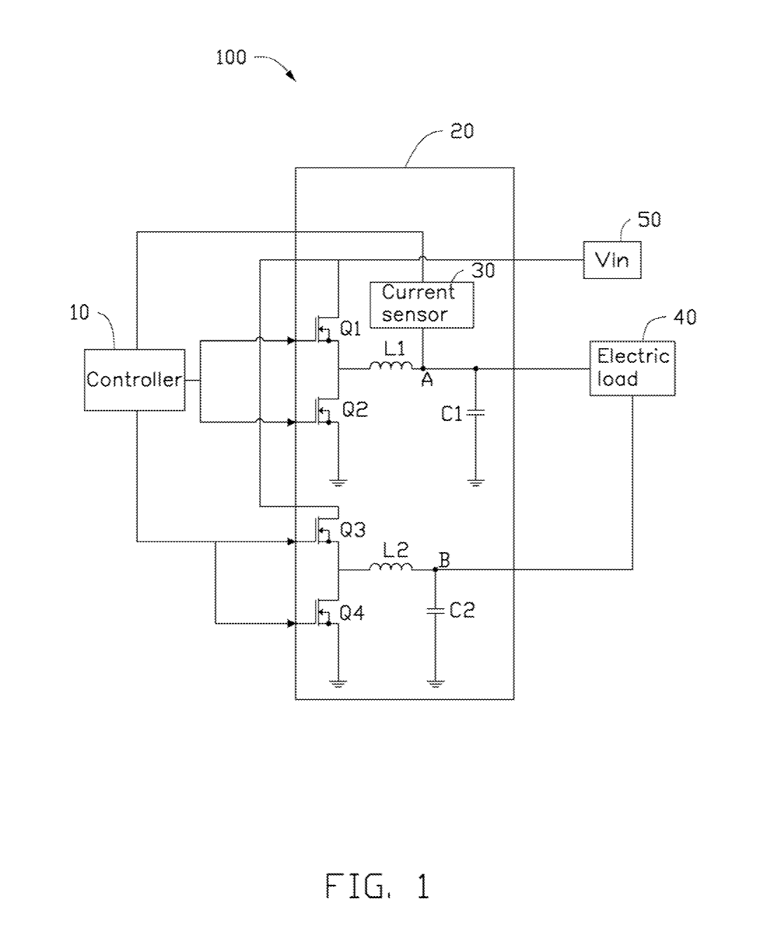

FIG. 1 shows an embodiment of a power supply circuit 100 comprising a controller 10, a power supply module 20, and a power source 50. The power supply module 20 is connected to an electric load 40 for supplying a working voltage to the electric load 40. In one embodiment, the electric load 40 is a GPU mounted on a motherboard. The power source 50 is a direct current (DC) power supply supplied by the motherboard, such as a +5V DC power supply.

The power supply module 20 includes a first output channel which comprises a first transistor Q1, a second transistor Q2, a first inductor L1, and a first capacitor C1, and a second output channel which comprises a third transistor Q3, a fourth transistor Q4, a second inductor L2, and a second capacitor C2. In one embodiment, each of the first transistor Q1, the second transistor Q2, the third transistor Q3, and the fourth transistor Q4 is an N-channel MOSFET.

The controller 10 is connected to a base terminal of each of the transistors Q1-Q4 for switching on or off the transistors Q1-Q4 automatically. A first drain terminal of the first transistor Q1 is coupled to the power source 50. A first source terminal of the first transistor Q1 is connected to a second drain terminal of the second transistor Q2. A second source terminal of the second transistor Q2 is connected to ground. A third drain terminal of the third transistor Q3 is coupled to the power source 50. A third source terminal of the third transistor Q3 is connected to a fourth drain terminal of the fourth transistor Q4. A fourth source terminal of the fourth transistor Q4 is connected to ground. A first terminal of the first inductor L1 is connected to the first source terminal and the second drain terminal. A second terminal of the first inductor L1 is connected to a node A. A first terminal of the first capacitor C1 is connected to the node A. A second terminal of the first capacitor C1 is connected to ground. A first terminal of the second inductor L2 is connected to the third source terminal and the fourth drain terminal A second terminal of the second inductor L2 is connected to a node B. A first terminal of the second capacitor C2 is connected to the node B. A second terminal of the second capacitor C2 is connected to ground.

A current sensor 30 is connected to the node A for detecting a current flowing from the first inductor L1 to the electric load 40. The controller 10 is connected to the current sensor 30 and selectively activates or deactivates the first output channel and the second output channel according to the current detected by the current sensor 30.

When the first output channel is activated and the second output channel is deactivated, the power supply module 20 functions as a single phase power supply. The current sensor 30 detects the current output from the first output channel to the electric load 40. If the current is less than or equal to a first determined value, the power supply module 20 maintains the single phase power supply mode. If the current is greater than the first determined value, the controller 10 activates the second output channel. The power supply module 20 is switched from the single power supply to a two-phase power supply. Both the first output channel and the second output channel provides pulse width modulation (PWM) voltage signals to the electric load 40.

When both of the first output channel and the second output channel are activated, the current flowing from the first output channel is decreased. A total output current of the power supply module 20 is unchanged. The current sensor 30 detects the current output from the first output channel. If the current is less than or equal to a second determined value, the power supply module 20 deactivates the second output channel. The power supply module 20 is switched from the two-phase power supply to the single phase power supply. If the current is greater than the second determined value, the power supply module 20 maintains the two-phase power supply mode. In one embodiment, the second predetermined value is about half of the first predetermined value.

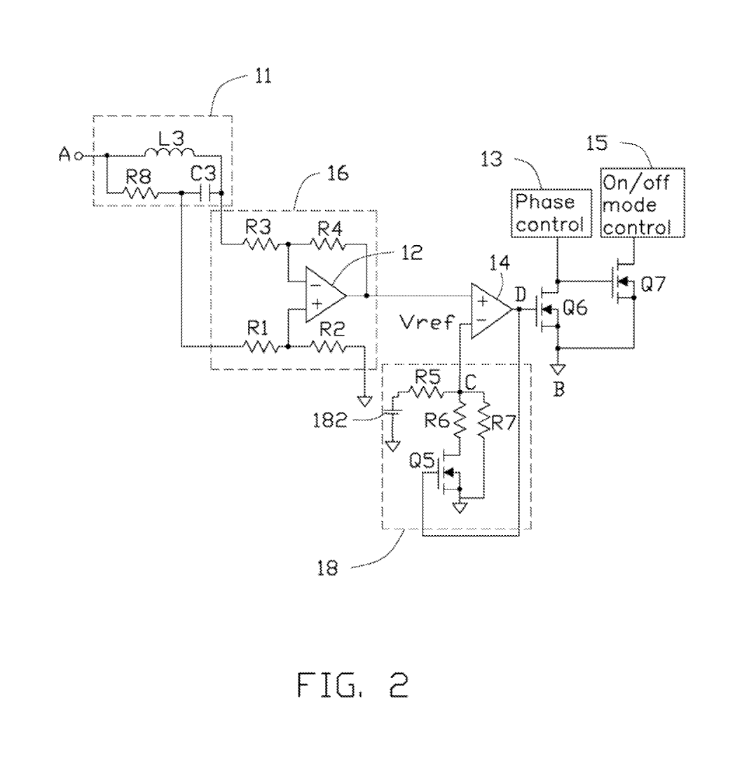

FIG. 2 shows an embodiment of the controller 10 comprising a conversion circuit 11, a voltage amplifier circuit 16, and a reference voltage providing circuit 18.

The conversion circuit 11 includes a third inductor L3, an eighth resistor R8, and a third capacitor C3. The eighth resistor R8 and the third capacitor C3 are connected in series. The third inductor L3 is connected in parallel with the series circuit consisting of the eighth resistor R8 and the third capacitor C3. A first terminal of the third inductor L3 is connected to the node A for receiving the current flowing from the first inductor L1. A second terminal of the third inductor L3 is connected to the third capacitor C3. The conversion circuit 11 converts the current flowing from the first inductor L1 to a corresponding voltage signal.

The voltage amplifier circuit 16 includes a first amplifier 12 and a first resistor R1, a second resistor R2, a third resistor R3, and a fourth resistor R4 connected to the first amplifier 12. In one embodiment, a resistance of the first resistor R1 is substantially equal to a resistance of the third resistor R3. A resistance of the second resistor R2 is substantially equal to a resistance of the fourth resistor R4. The voltage amplifier circuit 16 amplifies the voltage output from the conversion circuit 11.

The controller 10 further comprises a second amplifier 14. A positive terminal of the second amplifier 14 is connected to an output terminal of the first amplifier 12. A negative terminal of the second amplifier 14 is coupled to a reference voltage provided by the reference voltage providing circuit 18. The second amplifier 14 compares the amplified voltage output from the voltage amplifier circuit 12 with the reference voltage and outputs a control signal according to the comparison result.

The reference voltage providing circuit 18 includes a power supply 182, a fifth transistor Q5, a fifth resistor R5, a sixth resistor R6, and a seventh resistor R7. A positive terminal of the power supply 182 is connected to a first terminal of the fifth resistor R5. A negative terminal of the power supply 182 is connected to ground. A second terminal of the fifth resistor R5 is connected to a node C. A first terminal of the sixth resistor R6 is connected to the node C. A second terminal of the sixth resistor R6 is connected to a fifth drain terminal of the fifth transistor Q5. A first terminal of the seventh resistor R7 is connected to the node C. A second terminal of the seventh resistor R7 is connected to ground. A fifth gate terminal of the fifth transistor Q5 is connected to a node D. A fifth source terminal of the fifth transistor Q5 is connected to ground. The output terminal of the second amplifier 14 is connected to the node D. A sixth base terminal of a sixth transistor Q6 is connected to the node D. A sixth drain terminal of the sixth transistor Q6 is connected to a first control terminal 13. A sixth source terminal of the sixth transistor Q6 is connected to ground. A seventh base terminal of a seventh transistor Q7 is connected to the sixth drain terminal. A seventh drain terminal of the seventh transistor Q7 is connected to a second control terminal 15. A seventh source terminal of the seventh transistor Q7 is connected to ground.

The conversion circuit 11 converts the current output from the first inductor L1 to the corresponding voltage signal. The voltage amplifier circuit 16 amplifies the voltage output from the conversion circuit 11 and outputs an amplified voltage to the second amplifier 14. The second amplifier 14 compares the amplified voltage with the reference voltage. If the amplified voltage is greater than the reference voltage, the second amplifier 14 outputs a high level signal to the node D. If the amplified voltage is less than or equal to the reference voltage, the second amplifier 14 outputs a low level signal to the node D. On/off states of the sixth transistor Q6 and the seventh transistor Q7 vary when a voltage level of the output signal of the second amplifier 14 varies. Signals of the first control terminal 13 and the second control terminal vary when on/off states of the sixth transistor Q6 and the seventh transistor Q7 vary. In one embodiment, the controller 10 controls a phase number of the power supply module 10 according to the signal of the first control terminal 13. The controller 10 controls on/off states of the transistors Q1-Q4 according to the signal of the second control terminal 15.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A power supply circuit, configured to supply a working voltage for an electric load, comprising:
a controller;
a power supply module connected to the controller and comprising a first output channel and a second output channel both connected to the electric load; and
a current sensor connected to the controller, and sensing a current output from the first output channel;
wherein either the first output channel or the second output channel is deactivated by the controller when the current sensed by the current sensor is less than or equal to a predetermined current value; both of the first output channel and the second output channel are activated when the current sensed by the current sensor is greater than the predetermined current value.

2. The power supply circuit of claim 1, wherein when one of the first output channel and the second output channel is deactivated, the power supply module is a single phase power supply; when both of the first output channel and the second output channel are activated, the power supply module is a two-phase power supply.

3. The power supply circuit of claim 1, wherein the first output channel comprises a first transistor, a second transistor connected to the first transistor, a first inductor connected to the first transistor and the second transistor, and a first capacitor connected to the first inductor and the electric load; the second output channel comprises a third first transistor, a fourth transistor connected to the third transistor, a second inductor connected to the third transistor and the fourth transistor, and a second capacitor connected to the second inductor and the electric load.

4. The power supply circuit of claim 3, wherein the current sensor is connected to a first output terminal of the first output channel, the first inductor and the first capacitor are connected to the first output terminal, and the first output terminal is connected to the electric load.

5. The power supply circuit of claim 4, wherein the controller comprises a conversion circuit connected to the first output terminal, and the conversion circuit converts the current output from the first output terminal to a voltage signal.

6. The power supply circuit of claim 5, wherein the controller further comprises a voltage amplifier circuit connected to the conversion circuit, and the voltage amplifier circuit amplifies the voltage signal converted by the conversion circuit.

7. The power supply circuit of claim 6, wherein the controller further comprises an amplifier connected to the voltage amplifier circuit, and the amplifier compares the amplified voltage with a reference voltage.

8. The power supply circuit of claim 7, further comprising a reference voltage providing circuit connected to the operational amplifier and providing the reference voltage to the operational amplifier.

9. The power supply circuit of claim 8, wherein the reference voltage providing circuit comprises a resistor and a fifth transistor connected to the operational amplifier via the resistor; the controller further comprises a sixth transistor connected to an output terminal of the operational amplifier, and a seventh transistor connected to the sixth transistor.

10. The power supply circuit of claim 9, wherein each of the first transistor, the second transistor, the third transistor, the fourth transistor, the fifth transistor, the sixth transistor, and the seventh transistor is an N-channel MOSFET; the controller is capable of selecting the single phase supply mode or the two-phase power supply mode according to a signal of a drain terminal of the sixth transistor, and the controller is capable of switching on or off the first transistor, the second transistor, the third transistor, and the fourth transistor.

11. A power supply circuit adapted to supply a working voltage for an electric load, the power supply comprising a power supply module and a controller connected to the power supply module, wherein the power supply module comprises a first output channel, a second output channel, and a current sensor connected to the first output channel; the current sensor senses a current output from the first output channel; each of the first output channel and the second output channel are connected to the electric load and capable of providing a voltage signal to the electric load; the controller is capable of activating or deactivating the first output channel and the second output channel by comparing the current sensed between the current sensor and a predetermined current value.

12. The power supply circuit of claim 11, wherein when either the first output channel or the second output channel is deactivated, the power supply module is a single phase power supply; when both of the first output channel and the second output channel are activated, the power supply module is a two-phase power supply.

13. The power supply circuit of claim 11, wherein the first output channel comprises a first transistor, a second transistor connected to the first transistor, a first inductor connected to the first transistor and the second transistor, and a first capacitor connected to the first inductor and the electric load; the second output channel comprises a third first transistor, a fourth transistor connected to the third transistor, a second inductor connected to the third transistor and the fourth transistor, and a second capacitor connected to the second inductor and the electric load.

14. The power supply circuit of claim 13, wherein the current sensor is connected to a first output terminal of the first output channel, the first inductor and the first capacitor are connected to the first output terminal, and the first output terminal is connected to the electric load.

15. The power supply circuit of claim 14, wherein the controller comprises a conversion circuit connected to the first output terminal, and the conversion circuit converts the current output from the first output terminal to a voltage signal.

16. The power supply circuit of claim 15, wherein the controller further comprises a voltage amplifier circuit connected to the conversion circuit, and the voltage amplifier circuit amplifies the voltage signal converted by the conversion circuit.

17. The power supply circuit of claim 16, wherein the controller further comprises an amplifier connected to the voltage amplifier circuit, and the amplifier compares the amplified voltage with a reference voltage.

18. The power supply circuit of claim 17, further comprising a reference voltage providing circuit connected to the operational amplifier and providing the reference voltage to the operational amplifier.

19. The power supply circuit of claim 18, wherein the reference voltage providing circuit comprises a resistor and a fifth transistor connected to the operational amplifier via the resistor; the controller further comprises a sixth transistor connected to an output terminal of the operational amplifier, and a seventh transistor connected to the sixth transistor.

20. The power supply circuit of claim 19, wherein each of the first transistor, the second transistor, the third transistor, the fourth transistor, the fifth transistor, the sixth transistor, and the seventh transistor is an N-channel MOSFET; the controller is capable of selecting the single phase supply mode or the two-phase power supply mode according to a signal of a drain terminal of the sixth transistor, and the controller is capable of switching on or off the first transistor, the second transistor, the third transistor, and the fourth transistor.
